(19) United States
(12) Patent Application Publication
(10) Pub. No.: US 2025/0057239 A1
(43) Pub. Date: Feb. 20, 2025

(54) AEROSOL PROVISION DEVICE

(71) Applicant: NICOVENTURES TRADING LIMITED, London (GB)

(72) Inventor: Dean COWAN, London (GB)

(21) Appl. No.: 18/723,448

(22) PCT Filed: Dec. 19, 2022
(86) PCT No.: PCT/EP2022/086652

§ 371 Date: Jun. 23, 2024

(30) Foreign Application Priority Data
Dec. 24, 2021 (GB) 2118990.7

(51) Int. Cl. A24F 40/48; A24F 40/46; A24F 40/465; H01M 10/613; H01M 10/623; H01M 10/6556; H01M 50/202; H01M 50/247

(52) U.S. Cl. CPC A24F 40/48; A24F 40/46; A24F 40/465; H01M 10/613; H01M 10/623; H01M 10/6556; H01M 50/202; H01M 50/247; H01M 2220/30

(57) ABSTRACT

An aerosol provision device for generating an aerosol from aerosol-generating material including a power source, a receptacle defining a heating zone configured to receive at least a portion of an article having aerosol-generating material, and a flow passage member extending from the receptacle, wherein the power source is in thermal conductive contact with the flow passage member to provide a thermal heat transfer between the power source and the flow passage member.

### RELATED APPLICATIONS

The present application is a National Phase entry of PCT Application No. PCT/EP2022/086652 filed Dec. 19, 2022, which claims priority to GB Application No. 2118990.7 filed Dec. 24, 2021, each of which is hereby incorporated by reference in their entirety.

### TECHNICAL FIELD

The present invention relates to an aerosol provision device for generating an aerosol from aerosol-generating material. The present invention also relates to an aerosol provision system comprising an aerosol provision device and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device for generating an aerosol from aerosol-generating material comprising a power source, a receptacle defining a heating zone configured to receive at least a portion of an article comprising aerosol-generating material, and a flow passage member extending from the receptacle, wherein the power source is in thermal conductive contact with the flow passage member to provide a thermal heat transfer between the power source and the flow passage member.

The thermal conductive contact may be arranged to transfer heat from the power source to the flow passage member.

The power source may be a battery.

The battery may at least partially encircle at least a portion of the flow passage member.

The flow passage member defines a flow passage.

The battery may be a wrapped battery.

The battery may be a soft cell battery.

The battery may extend around at least a third of a circumference of the flow passage member.

The battery may extend around at least half of a circumference of the flow passage member.

The aerosol provision device may further comprise a heating assembly including a heating element configured to heat the heating zone.

The power supply may be configured to supply energy to heat the heating element.

The power supply may be spaced from the heating assembly.

The heating assembly may be an inductive heating assembly.

The heating assembly may be a resistive heating assembly.

The thermal conductive contact may be direct thermal conductive contact.

An outer side of the power source may be in contact with the flow passage member.

The thermal conductive contact may be indirect thermal conductive contact.

The aerosol provision device may comprise a conductive member between the power source and the flow passage member.

The conductive member may support the power supply.

The conductive member may at least partially encircle at least a portion of the flow passage member.

The conductive member may be integrally formed with the flow passage member.

The conductive member may support the power supply.

The aerosol provision device may comprise an air inlet, wherein the flow passage member may be between the air inlet and the receptacle.

The aerosol provision device may comprise a filter cavity, wherein the flow passage member may be between the filter cavity and the receptacle.

The aerosol provision device may comprise a mouthpiece, wherein the flow passage member may be between the mouthpiece and the receptacle.

The aerosol provision device may comprise multiple batteries each in thermal contact with the flow passage member.

An outer surface of the flow passage member may be formed from a heat conductive material.

The heat conductive material may comprise Aluminum.

In accordance with some embodiments described herein, there is provided an aerosol provision system comprising an aerosol provision device according to any of the above, and an article comprising aerosol generating material adapted to be at least partially received in the receptacle.

### BRIEF DESCRIPTION OF DRAWINGS

Embodiments will now be described, by way of example only, and with reference to the accompanying drawings in which:

FIG. 1 shows a cross-sectional view of an aerosol generating system including an aerosol generating device, an article containing aerosol generating material, and a filter element; FIG. 2 shows a cross-sectional view of another aerosol generating system including an aerosol generating device, an article containing aerosol generating material, and a filter element; and

FIG. 3 shows a cross-sectional view of another aerosol generating system including an aerosol generating device, an article containing aerosol generating material, and a filter element.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt% or 70 wt % of amorphous solid, to about 90 wt %, 95 wt% or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

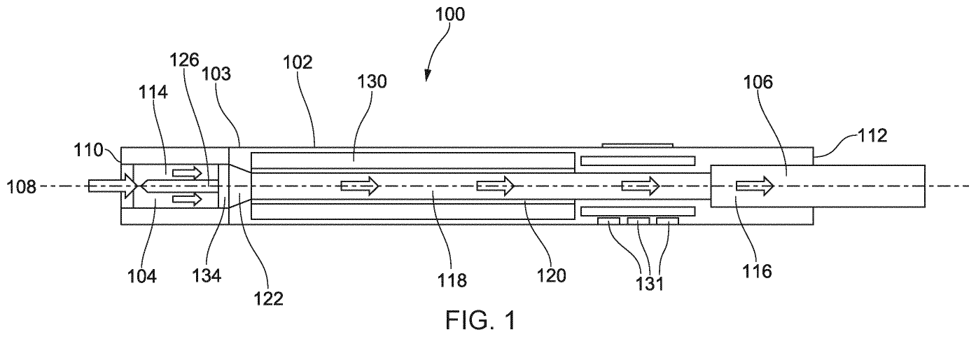

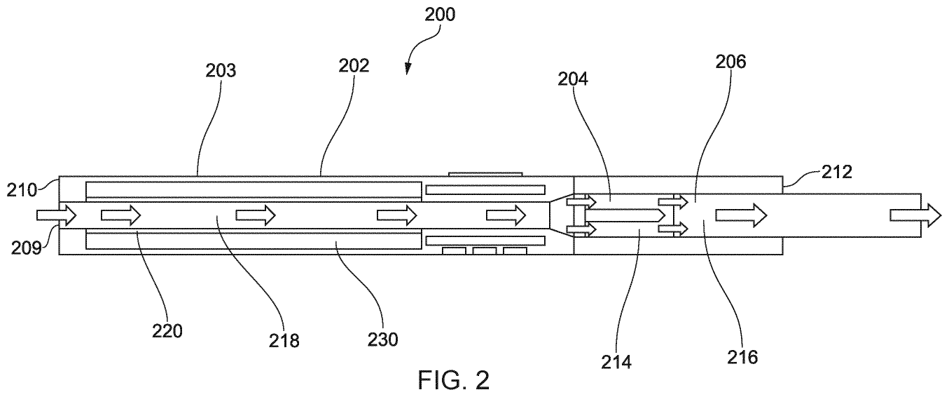

FIG. 1 shows a cross-section of an example aerosol generating system 100. The system 100 comprises an aerosol generating device 102 for generating aerosol from an aerosol generating material, and a consumable 105. The consumable 105 comprises an article 104 comprising aerosol generating material, and a filter element 106 for filtering air which has passed through the article 104. The article 104 and the filter element 106 are separate discrete elements. The article 104 acts as an aerosol generating element. The article 104 is replaceable. The filter element 106 is replaceable. Although described as a consumable herein, it will be understood that the article 104 and the filter element 106 may be separably provided, and may be separably replaceable. The filter element 106 protrudes from the device 102 to be received by a user's mouth. As the user does not use the article 104 as a mouthpiece, the article 104 may be fully received in the device 102. In embodiments, the article 104 protrudes from the device 102 to allow ease of insertion and removal. In other embodiments, the device 102 has an integral mouthpiece. In such embodiments, the filter element may be omitted.

The device 102 is a non-combustible aerosol generating device. The device 102 can be used to heat the article 104 comprising the aerosol generating material to generate an aerosol or other inhalable material which can be inhaled by a user of the device 102. The device 102 includes an aerosol generator for heating the article 104 comprising aerosol generating material. It will be appreciated that the device 102 may include other components not shown in FIG. 1.

The device 102 comprises a body 103 defining a longitudinal axis 108 along which the article 104 and filter element 106 extend when received into the device 102. The device 102 is configured so that airflow through the device 102 travels into one end 110 of the body 103 and out of another end 112 of the body 103 and generally along the longitudinal axis 108. The device 102 is elongate and has two ends 110, 112.

A first end 110 is able to receive the article 104, and a second end 112 is able to receive the filter element 106. A receptacle 114 for receiving the article 104 is defined in the first end 110. The receptacle 114 acts as an article receptacle. The receptacle 114 defines a heating zone. A cavity 116 for receiving the filter element 106 is located in the second end 112. The cavity 116 acts as a filter cavity. The cavity 116 defines an air inlet. The two ends 110, 112 of the device are flat and the device 102 has a generally tubular outline with a generally oval cross section. However, alternative elongate shapes may be provided, and the ends 110, 112 may not be flat.

The body 103 has end surfaces 110, 112 of the device 102. The second end 112 of the device 102 closest to the cavity 116 may be known as the proximal end 112 (or mouth end) of the device 102 because, in use, it is closest to the mouth of the user. In use, a user inserts a filter element 106 into the cavity 116, operates the aerosol generator to begin heating the aerosol generating material in the article receptacle 114 and draws on the aerosol generated in the device 102. This causes the aerosol to flow through the device 102 along a flow path towards the proximal end 112 of the device 102.

The other, first, end 110 of the device 102 furthest away from the cavity 116 may be known as the distal end 110 of the device 102 because, in use, it is the end furthest away from the mouth of the user. As a user draws on the aerosol generated in the device 102, the aerosol flows in a direction towards the proximal end 112 of the device 102. The terms proximal and distal as applied to features of the device 102 will be described by reference to the relative positioning of such features with respect to each other in a proximal-distal direction along the longitudinal axis 108.

The receptacle 114 is generally cylindrical in shape. The receptacle 114 extends into the device 102 at the distal end 112. A central axis of the receptacle 114 extends along the longitudinal axis 108 of the device 102. In other embodiments, the receptacle is not cylindrical in shape and may, for example, have an oval or rectangular cross section. The receptacle 114 is shaped to complement or match the shape of the replaceable article 104 so that the article 104 fits into the receptacle 114. The receptacle 114 is open at the first end 110 of the device 102 to allow the replaceable article 104 to be placed therein.

The cavity 116 is also generally cylindrical in shape. A central axis of the cavity 116 coincides with the longitudinal axis 108 of the device and is also open at the second or proximal end 112 to allow the filter element 106 to be placed therein. The cavity 116 is shaped to complement or match the shape of a filter element 106 so that the filter element 106 fits into the cavity 116. The cavity 116 has the same diameter as the receptacle 114. However, the cavity 116 may have a larger or smaller diameter than the diameter of the receptacle 114.

The device 102 comprises a flow passage 118 (also referred to as a passage 118) extending between the receptacle 114 and the cavity 116. The flow passage 118 provides a path for airflow through the device 102. The device 102 comprises a converging portion 122 between the receptacle 114 and the flow passage 118. The converging portion 122 provides a gradual decrease in cross sectional area from the receptacle 114 to the flow passage 118. This may help to avoid increase turbulence of flow. In other embodiments, a converging portion is not present.

The flow passage 118 extends directly from the receptacle 114 to the cavity 116. However, in other embodiments the flow passage 118 may not extend directly from the receptacle 114 to the cavity 116 and there may be other components or passages therebetween. The flow passage 118 is in fluid communication with both the receptacle 114 and the cavity 116 to allow flow of air from the receptacle 114 to the cavity 116.

The flow passage 118 is elongate in shape. The flow passage 118 acts to space the cavity 116 apart from the receptacle 114. The flow passage 118 increases the distance and a flow path length between the cavity 116 and the receptacle 114.

The flow passage 118 illustrated is cylindrical in shape. However, other elongate shapes may be provided, for example an elongate shape with an oval or square cross section. The central axis of the flow passage 118 illustrated is linear, however in other embodiments the central axis is not linear and the flow passage 118 follows a non-linear path. The flow passage 118 may have a length to diameter ratio of at least five, and in embodiments a ratio of at least ten. The cross sectional area of the flow passage 118 is smaller than the cross sectional area of both the receptacle 114 and the cavity 116. This may help the flow passage 118 to provide resistance (by friction) to airflow through it. In other embodiments, the cross sectional area of the flow passage 118 may be the same as or larger than the cross sectional area of the receptacle 114 and the cavity 116. Although one flow passage 118 is shown in this embodiment, in other embodiments multiple flow passages 118 are provided.

The flow passage 118 is defined by a tubular member 120 within the device 102. The tubular member 120 acts as a flow passage member. As air flows through the passage 118 the inner surface of the tubular member 120 exerts frictional forces on the airflow in the opposite direction to the airflow direction. This frictional force can be felt by the user when inhaling. In this embodiment, the tubular member 120 is a separate distinct member, but in other embodiments the tubular member 120 may be integral with the body 103 of the device.

The device 102 has a shoulder 124 between the passage 118 and the cavity 116. The shoulder 124 acts as a stop for a filter element 106 when inserted into the cavity 116 to limit insertion of the filter element 106 in the cavity 116. In other embodiments, a stop for the filter element 106 is provided in the form of a flange or other protrusion. The stop is configured so that the filter element 106 protrudes from the cavity 116. The protruding portion is useable as a mouthpiece. In embodiments, the device 102 comprises a mouthpiece. In such an embodiment, the cavity 116 may be configured to fully receive the filter element 106.

The device 102 may comprise a user-operable control element (not shown), such as a button or switch, which operates the device 102 when operated, e.g. pressed. For example, a user may activate the device 102 by pressing the switch.

The device 102 includes an aerosol generator for heating the replaceable article 104 comprising aerosol generating material. The aerosol generator includes a heating assembly 126. The heating assembly 126 is configured to heat the aerosol-generating material inserted into the device 102, such that an aerosol is generated from the aerosol generating material.

The apparatus may also include a controller to control heating provided by the heating assembly 126. The control circuit, if present, may be configured to activate and deactivate the heating assembly 126 based on a user operating the control element. For example, the controller 128 may activate the heating assembly 126 in response to a user operating the switch (not shown).

The device 102 includes a power source 130 which supplies electrical power to the heating assembly 126. The heating assembly 126 converts the supplied electrical energy into heat energy for heating the aerosol-generating material.

The power source 130 illustrated is a rechargeable battery 130. Examples of suitable batteries include, for example, a lithium battery (such as a lithium-ion battery), a nickel battery (such as a nickel-cadmium battery), and an alkaline battery. The device 102 includes ports 131 for recharging the battery 130. The ports 131 are located on a side of the body 103 at a different axial position to the battery 130. However, the ports 131 may be located on any suitable location on the device 102, for example at the same axial position to the battery 130, or at an end 110, 112 of the device 102. There may be more or fewer ports 131 to those shown. In other embodiments, the device 102 does not have ports 131 and the battery is removed to be recharged. In other embodiments, the battery is not rechargeable.

Although one battery 130 is shown, there may be more than one battery provided, and each battery may be in thermal contact with a different portion of the passage 118.

The battery 130 is a wrapped battery which encircles the passage 118. The battery 130 is cylindrical in shape. The battery 130 extends axially along more than half of the passage 118. The battery 130 is in direct thermal contact with the tubular member 120. Direct thermal contact means that the two components directly contact one another. When used to supply power to the heating assembly 126, the battery 130 itself will increase in temperature. Since the battery 130 is in thermal contact with the tubular member 120, an increase in temperature of the battery 130 will cause heat energy to be transferred from the battery 130 to the tubular member 120 via conduction. The tubular member 120 will be heated by the battery 130 due to the thermal contact between them. Heating the tubular member 120 will cause heating to airflow (illustrated by arrows) through the passage 118. The battery 130 may be a soft cell battery.

In embodiments, the battery 130 partially encircles the passage 118, and may instead circumferentially encircle only a portion of the passage 118, for example a third or a half of a circumference of the passage 118. The greater the circumference of the passage 118 that the battery 130 encircles, the more efficient heating that the battery 130 can provide via conduction. Furthermore, a larger battery 130 may have a higher power potential for the heating assembly 126. However, it may be desirable for the battery 130 to only cover half or less than half of the circumference of the passage 118, because this may help to provide more space for other components in the device 120, and may aid in ease of maintenance and manufacturing because the battery may be easier to produce and to insert into the device 120.

In other embodiments, the battery 130 does not extend axially along a majority of the passage 118 and may extend along a minority (i.e. less than half) of the passage 118. An advantage to the battery 130 extending axially along a majority of the passage 118 is that the battery 130 can provide heating by conduction along a greater length of the passage 118, thus providing more effective heating to airflow through the passage 118. A battery 130 which extends axially along a minority of the passage 118 may be advantageous because it may help to provide more space in the device 102 for other components (for example a control system and switch system).

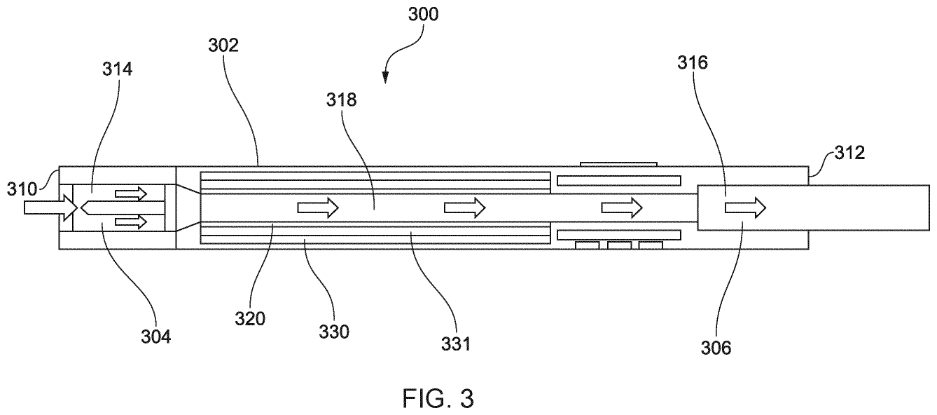

Although the battery 130 illustrated is in direct thermal contact with the tubular member 120, in other embodiments the battery 130 may be in indirect thermal contact with the tubular member 120 (as discussed in more detail in relation to FIG. 3). In yet other embodiments, the tubular member 120 and the battery 130 may be integrally formed such that an inner surface of the battery 130 provides at least a portion of a surface of the passage 118.

A device 102 with a passage 118 can be more elongate than a device 102 without a passage 118. This may be advantageous because the device 102 may be more ergonomic and more familiar to the user. For example, the device 102 may more closely resemble a cigarette. Providing heating by the battery 130 also provides a more efficient device, because heat produced by the battery 130 is not wasted. Auxiliary heating of the passage 118 by the battery helps to minimize the formation of condensate in the passage 118. Heating of the passage 118 through use of residual heat from the battery 130 may aid with efficiency of the device as heating provided by the heating assembly is directed to heating the aerosol generating heating material, and may be at least partially isolated from the tubular member 120.

The power source 130 is electrically coupled to the heating assembly 126 to supply electrical power when required. The power source 130 may be controlled by a controller, if present.

The heating assembly 126 may comprise various components to heat the aerosol generating material of the article 104 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a heating element suitably positioned with respect to the inductive element, and generates eddy currents inside the heating element. The heating element is also known as a susceptor. The heating element has electrical resistance to the eddy currents, and hence the flow of the eddy currents against this resistance causes the susceptor to be heated by Joule heating. In cases where the heating element comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the heating element, allowing for rapid heating. Further, there need not be any physical contact between the inductive element and the heating element, allowing for enhanced freedom in construction and application.

The device comprises a heating element 132. The heating element 132 is in the form of an elongate member which protrudes in the receptacle 114. The elongate member may be configured as a pin or blade, for example. The heating element 132 extends into the article 104 when the article 104 is inserted into the device 102. The heating element 132 acts as an internal heating element. The heating element 132 acts to heat the article 104. In other embodiments, the heating element 132 may be an external heating element. The heating element in embodiments encircles an article 104 or the device 102 may comprise both an internal or external heating element. The external heating element encircles the heating zone. In embodiments, the heating element defines the heating zone. The heating element forms at least part of the receptacle 114.

In other embodiments, the feature acting as the heating element 132 may not be limited to being inductively heated. The feature, acting as the heating element, may be heatable by electrical resistance, for example. The aerosol generator 200 may comprise electrical contacts for electrical connection with the apparatus for electrically activating the heating element by passing a flow of electrical energy through the heating element. Such resistive heating may be provided to different element.

The arrows in FIG. 1 illustrate an airflow path when the device 102 is in use. As shown, an article 104 has been placed into the receptacle 114. In use, the user heats the article 104 by turning on the device 102. Once the device 102 has sufficiently heated the article 104 such that it has started to produce aerosol generating material, the user can inhale aerosol generating material using the filter element 106 as a mouthpiece. As illustrated by arrows, this inhalation causes air to flow into the receptacle 114 from the first end 110. There, it combines with aerosol generated in the article 104. The aerosol then travels through the device and through the filter element 116 to the user. The airflow path is defined by the receptacle 114, at least one hole (not shown) in a wall 134 at the end of the receptacle 114 (although in other embodiments a wall is not provided), the converging portion 122, the passage 118, and the filter element 106. Once the aerosol has travelled along this path it can be inhaled by the user, allowing the user to ingest the aerosol generated by the article 104. As the air flows through the passage 118, it is heated by conduction by the battery 118.

The filter element 106 acts as a filter to prevent inhalation of particles of a certain size and/or type by the user. The amount and type of filtration can be chosen depending on the device at hand and user preferences.

Another embodiment of an aerosol generating system 200 is illustrated in FIG. 2. Features of the configurations described above are applicable to the configuration described below but are omitted from detailed discussion for clarity. Like reference numerals in this embodiment represent equivalent features to those described in the previous embodiment.

The system 200 illustrated in FIG. 2 differs from the system 100 illustrated in FIG. 1 in that the filter element 206 and the aerosol generating article 204 are both received in the second side 212 of the device 202. The consumable comprises the article 204 and the filter element 206 and is inserted into the second end 112. The consumable may be inserted as one element into the receptacle 214 formed in the second side 212 of the device 202. In other embodiments, the article 204 and the filter element 206 are discrete separate parts, and the filter element 206 is at least partially inserted into the receptacle 214 subsequent to the article 204 being inserted into the receptacle 214. The passage 218 extends from the first end 110 to the receptacle 214. The consumable including the aerosol generating material is received at the proximal end 212 of the device 202. The passage 118 extends from an air inlet 209. The air inlet 209 is at the distal end 210 of the device 202. The passage 218 extends between the receptacle 214 and the air inlet 209.

The battery 203 is similar to the battery 103 described in relation to FIG. 1. The battery 203 is in thermal contact with the tubular member 220 to heat airflow through the passage 218. This means that airflow into the passage 218 from the second side 212 is heated by conduction by the battery 218, so that the air is at a higher temperature when it reaches the receptacle 214 than if the battery had not been in thermal contact with the tubular member 220. The battery 230 in this embodiment provides similar advantages to the battery 130 described in FIG. 1.

Another embodiment of an aerosol generating system 300 is illustrated in FIG. 3. Features of the configurations described above are applicable to the configuration described below but are omitted from detailed discussion for clarity. Like reference numerals in this embodiment represent equivalent features to those described in the previous embodiments.

The system 300 illustrated in FIG. 3 differs from the system 100 illustrated in FIG. 1 in that the battery 330 and the tubular member 320 are in indirect thermal contact, rather than direct thermal contact. Such an arrangement may be applied to the embodiments described above with reference to either of FIG. 1 or FIG. 2. A component 331 acting as a conductive member is located between the tubular member 320 and the battery 330. As the battery 330 increases in temperature, the battery 330 heats the component 331, which in turn heats the tubular member 320. Thus, the battery 330 provides indirect heating of the tubular member 320 via conduction. This in turn heats air flowing through the passage 318 when the system 300 is in use. The component 331 may be formed from a thermally conductive material, for example a metal. The component 331 may act to support the battery 330. The component 331 may be integrally formed with the tubular member 320.

In any of the embodiments described, the device 102 may be configured to heat the article by producing a varying magnetic field configured to heat a susceptor heating element positioned within the article. That is, the article itself may comprise a heating element. When located in the heating region, the heating element positioned within the article generates heat in the presence of the varying magnetic field and thereby heats the article and produces aerosolized material from the aerosol-generating material.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating an aerosol from aerosol-generating material comprising:
a power source;
a receptacle defining a heating zone configured to receive at least a portion of an article comprising aerosol-generating material; and
a flow passage member extending from the receptacle;
wherein the power source is in thermal conductive contact with the flow passage member to provide a thermal heat transfer between the power source and the flow passage member.

2. The aerosol provision device according to claim 1, wherein the thermal conductive contact is arranged to transfer heat from the power source to the flow passage member.

3. The aerosol provision device according to claim 1, wherein the power source is a battery.

4. The aerosol provision device according to claim 3, wherein the battery at least partially encircles at least a portion of the flow passage member.

5. The aerosol provision device according to claim 3, wherein the battery is a wrapped battery and/or a soft cell battery.

6. The aerosol provision device according to claim any of claims 3, wherein the battery extends around at least a third of a circumference of the flow passage member.

7. The aerosol provision device according to claim any of claims 1, further comprising a heating assembly including a heating element configured to heat the heating zone.

8. The aerosol provision device according to claim 7, wherein the power supply is configured to supply energy to heat the heating element.

9. The aerosol provision device according to claim 7, wherein the heating assembly is an inductive heating assembly.

10. The aerosol provision device according to claim 7, wherein the heating assembly is a resistive heating assembly.

11. The aerosol provision device according to claim any of claims 1, wherein the thermal conductive contact is direct thermal conductive contact.

12. The aerosol provision device according to claim 11, wherein an outer side of the power source is in contact with the flow passage member.

13. The aerosol provision device according to claim any of claims 1, wherein the thermal conductive contact is indirect thermal conductive contact.

14. The aerosol provision device according to claim 13, comprising a conductive member between the power source and the flow passage member.

15. The aerosol provision device according to claim 14, wherein the conductive member at least partially encircles at least a portion of the flow passage member.

16. The aerosol provision device according to claim 14, wherein the conductive member is integrally formed with the flow passage member.

17. The aerosol provision device according to claim any of claims 1, comprising an air inlet, wherein the flow passage member is between the air inlet and the receptacle.

18. The aerosol provision device according to claim any of claims 1, comprising a filter cavity, wherein the flow passage member is between the filter cavity and the receptacle.

19. The aerosol provision device according to claim any of claims 1, comprising a mouthpiece, wherein the flow passage member is between the mouthpiece and the receptacle.

20. An aerosol provision system comprising:
an aerosol provision device according to claim 1; and
an article comprising aerosol generating material adapted to be at least partially received in the receptacle.
